(19) United States
(12) Patent Application Publication
(10) Pub. No.: US 2005/0006977 A1
(43) Pub. Date: Jan. 13, 2005

(54) Apparatus and methods for winding dynamo-electric machine components

(76) Inventors: Raffaele Becherucci, Scandicci (IT); Gianfranco Stratico, Siena (IT)

Correspondence Address: FISH & NEAVE LLP, 1251 AVENUE OF THE AMERICAS, 50TH FLOOR, NEW YORK, NY, 10020-1105, US

(21) Appl. No.: 10/851,720

(22) Filed: May 20, 2004

Related U.S. Application Data
(60) Provisional application No. 60/472,707, filed on May 21, 2003.
(60) Provisional application No. 60/484,453, filed on Jul. 1, 2003.
(60) Provisional application No. 60/487,565, filed on Jul. 14, 2003.

(51) Int. Cl. H02K 5/24; H02K 1/12

(52) U.S. Cl. 310/254

(57) ABSTRACT

Apparatus and methods for winding dynamo-electric machine components are provided. A dynamo-electric machine component may be provided that includes an annular body portion that is at least partially constructed from an insulating material, a plurality of members extending radially inward from the body portion forming a plurality of slots therebetween, and wire coils that are received within the plurality of slots. Each wire coil may extend from one slot of the plurality of slots to another slot of the plurality of slots. Wire coils may be assembled on such a dynamo-electric machine component using a ram member that positions the wire coils with respect to the component and an annular member that presses a portion of the wire coils against the body portion of the component to maintain the position of the coils.

This application claims the benefit of U.S. provisional patent application Nos. 60/472,707, filed May 21, 2003, 60/484,453, filed Jul. 1, 2003, and 60/487,565, filed Jul. 14, 2003, all of which are hereby incorporated by reference herein in their entireties.

### BACKGROUND OF THE INVENTION

The present invention relates to improved cores for dynamo-electric machines and to apparatus and methods for their manufacture at production rates of an industrial environment. More particularly, the present invention relates to cores having coils of electrically-conducting strand, such as insulated copper wire.

For certain applications, present developments of dynamo-electric machines are leaning towards cores that no longer possess the ferromagnetic lamination stack. An extreme result of such development has led to ironless cores, in which the coils are suspended in air and need to be self-supporting to maintain their configuration. Self-support of the coil is a particular problem when the coil needs to be wound with thin wires. In fact, the turns of the coil can easily collapse if they are not supported. Self-support of the coil can be achieved as a result of the reticular structure which is imposed on the conducting wire when forming the coil. More particularly, the reticular structure is produced during winding by coursing the conducting wire along a highly meshed pattern and simultaneously laying it on a support structure. Self-support of the coil results when the conducting wire is well-meshed to form the reticular structure.

As an alternative to the reticular structure for self-support of the coils, or as a supplement to enhance self-support of the coil, bonding of the conducting wire can be performed once the coils are formed. This bonding achieves that adjacent portions of the conducting wire are held together by an adhesive linkage, generated by a particular transformation of a surface component present on the conducting wire.

Formation of the self-supporting reticular structure requires complex and time-consuming winding operations, while bonding the coils requires costly bondable wire. Furthermore, when the coil is not self-supporting and only bonding is used, operations for forming the coil (e.g., winding) need to use extremely accurate and complex solutions for supporting the coils until the bonding result has been achieved.

The present invention provides a novel core and apparatus and methods for its manufacture, which avoid the need for the ferromagnetic lamination stack and reduce the difficulties of the prior art associated with self-supporting of the coils.

### SUMMARY OF THE INVENTION

In accordance with the present invention, apparatus and methods for winding dynamo-electric machine components are provided.

The present invention provides a wound core, which is particularly suitable for being the stator core of a dynamo-electric machine. The core of the present invention may be wound with coils having a high number of turns, which substantially fill all the available space occupied by the core. Furthermore, the coils of the core of the present invention may be wound and interconnected according to a variety of electrical schemes.

In some embodiments of the present invention, a dynamo-electric machine component may be provided. The component may include an annular body portion that is at least partially constructed from an insulating material. The component may include a plurality of members extending radially inward from the body portion forming a plurality of slots therebetween. The component may include wire coils that are received within the plurality of slots such that each wire coil extends from one slot of the plurality of slots to another slot of the plurality of slots.

In some embodiments of the present invention, apparatus for assembling wire coils on a dynamo-electric machine component may be provided. Such a component may have an annular body portion and a plurality of members extending radially inward from the body portion forming a plurality of slots therebetween. The apparatus of the present invention may include a ram member configured to be received within the body portion of the component to position a first portion of the wire coils within the plurality of slots and a second portion of the wire coils across opposing axial end portions of the body portion. The apparatus may include an annular member configured to be received within the body portion when the ram member is withdrawn from the body portion such that the first portion of the wire coils maintains its positioning with respect to the slots.

In some embodiments of the present invention, a method for assembling wire coils on a dynamo-electric machine component may be provided. Such a component may have an annular body portion and a plurality of members extending radially inward from the body portion forming a plurality of slots therebetween. The method of the present invention may include providing apparatus for assembling the wire coils on the component that includes a ram member and an annular member. The ram member may be advanced within the body portion of the component such that a first portion of the wire coils are positioned within the plurality of slots and a second portion of the wire coils are positioned across opposing axial end portions of the body portion. The annular member may be advanced within the body portion of the component when the ram member is withdrawn from the body portion such that the first portion of the wire coils maintains its positioning with respect to the slots.

Further features of the invention, its nature and various advantages will be more apparent from the accompanying drawings and the following detailed description.

### BRIEF DESCRIPTION OF THE DRAWINGS

FIG. 1 is a perspective view of an illustrative core in accordance with the present invention.

FIG. 2 is an axial sectional view of another illustrative core in accordance with the present invention, and as may be viewed from direction 2--2 of FIG. 5.

FIG. 3 is a view similar to that of FIG. 2, showing the perimeter extension which the coils of the core of FIG. 2 may have in the case of a particular electrical scheme in accordance with the present invention. Furthermore, FIG. 3 schematically and partially shows the manner in which the coils are connected to commutation sectors in the case of the particular electrical scheme in accordance with the present invention.

FIG. 4 is a schematic view of the electrical scheme demonstrated in FIG. 3 in accordance with the present invention.

FIG. 5 is a perspective view from direction 5 of FIG. 2 illustrating a coil which may be wound on the core of FIG. 2 in accordance with the present invention.

FIG. 6 is a view similar to FIG. 2 with the addition of an internal core that is rotated by the core of FIG. 2 in accordance with the present invention.

FIG. 7 is a sectional view of yet another illustrative core as may be viewed from direction 7--7 of FIG. 2 in accordance with the present invention.

FIGS. 8-10 are sectional views similar to FIG. 7, although rotated by 90°, illustrating manufacturing stages for producing the core of FIG. 7 in accordance with the present invention.

FIG. 11 is a sectional view from direction 11--11 of FIG. 8 in accordance with the present invention.

### DETAILED DESCRIPTION OF THE INVENTION

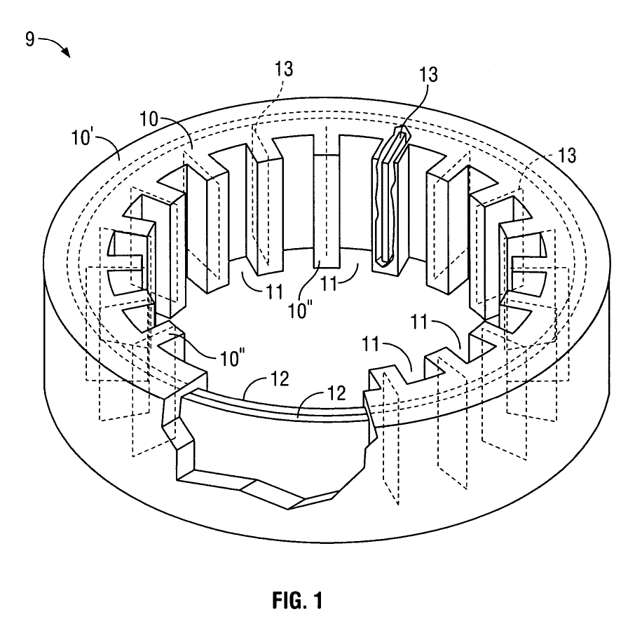

FIG. 1 shows a perspective view of an illustrative core in accordance with the present invention. Stator core 9 shown in FIG. 1 includes a core body 10 made of insulating material. Core body 10 is provided with annular ring portion 10′ and inner portion 10″ having coil receiving slots 11.

One or more rings 12 of ferromagnetic material may be embedded in annular ring portion 10′. Radial laminates 13 of ferromagnetic material may be embedded in inner portion 10″ adjacent to the coil receiving slots.

Coils of high density and of conducting wire of the type described, for example, in Becherucci et al. U.S. patent publication No. US 2004/0046476, published on May 8, 2003, which is hereby incorporated by reference herein in its entirety, may be located in coil receiving slots 11. The manufacturing operations and equipment described, for example, in Becherucci et al. U.S. patent publication No. US 2004/0046476, may be used to form the coils and locate them in coil receiving slots 11. Slot cover members with pole extensions, such as those described in Becherucci et al. U.S. patent publication No. US 2004/0046476, may be used to cover the coils when they have been located in coil receiving slots 11.

Rings 12, laminates 13, and the pole extensions augment and improve distribution of the field generated by the coils located in coil receiving slots 11.

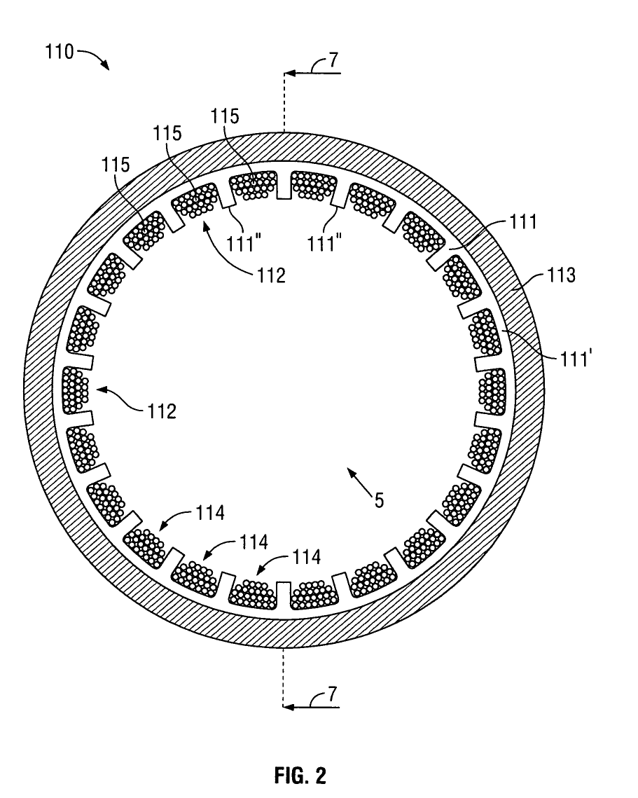

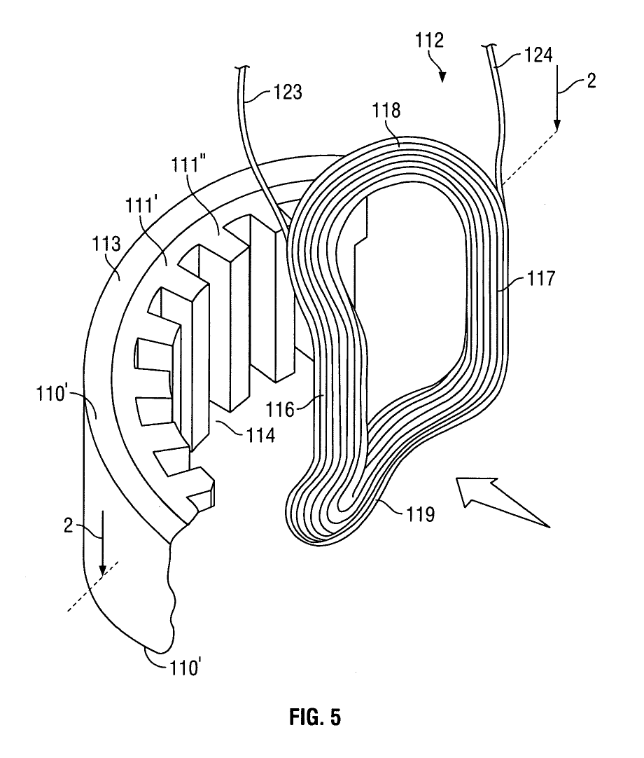

FIG. 2 shows a sectional view of another illustrative core in accordance with the present invention. The structure of core 110 includes a support structure 111, coils 112 (see also FIG. 5) of wound wire, and barrel member 113. Support structure 111 may be constructed, for example, of a plastic compound, and may include annular portion 111′, together with stemming neck portions 111″. Spacing 114 existing between adjacent neck portions 11″ may act as compartments, or slots, for receiving sections of coils 112 formed from wire turns 115. Barrel member 113 may include a thin annular ring of ferromagnetic material, which may encircle support structure 111. In order to optimize the use of the available magnetic field in core 110, barrel member 113 may be constructed of a ferromagnetic material. The plastic compound of support structure 111 may, for example, imbed metal particles.

Barrel member 113 and support structure 111 may be assembled together concentrically. In one example, barrel member 113 and support structure 111 may be joined to each other as a result of a plastic injection mold operation, in which barrel member 113 is used as an integral part of the mold and support structure 111 is formed by solidification of the injected plastic compound. Alternatively, support structure 111 may be produced separately, as a result of a plastic injection mold operation, and then fitted within barrel member 113. In this alternative embodiment, anchoring between support structure 111 and barrel member 113 may be accomplished using a variety of joining techniques, such as, for example, adhesive, a press fit, or any other suitable joining technique.

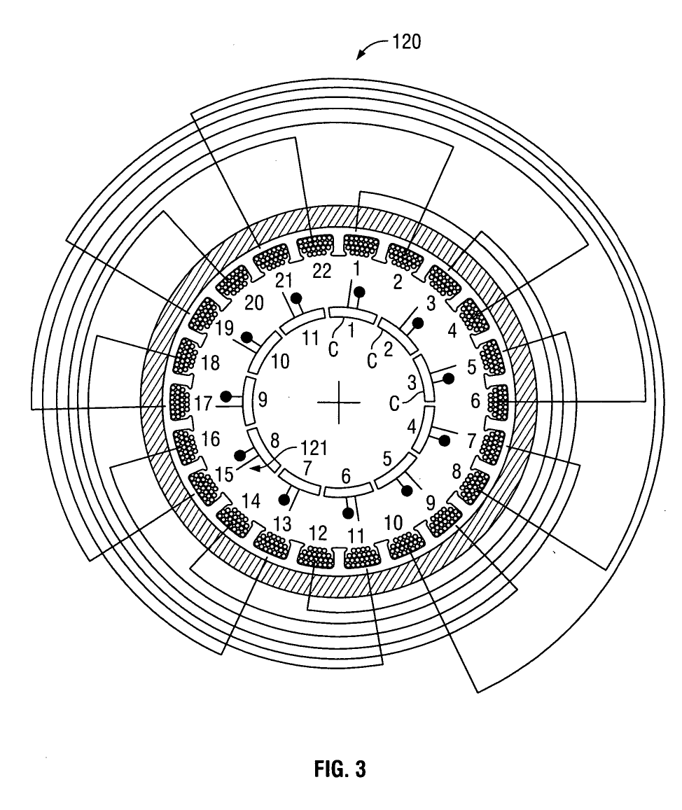

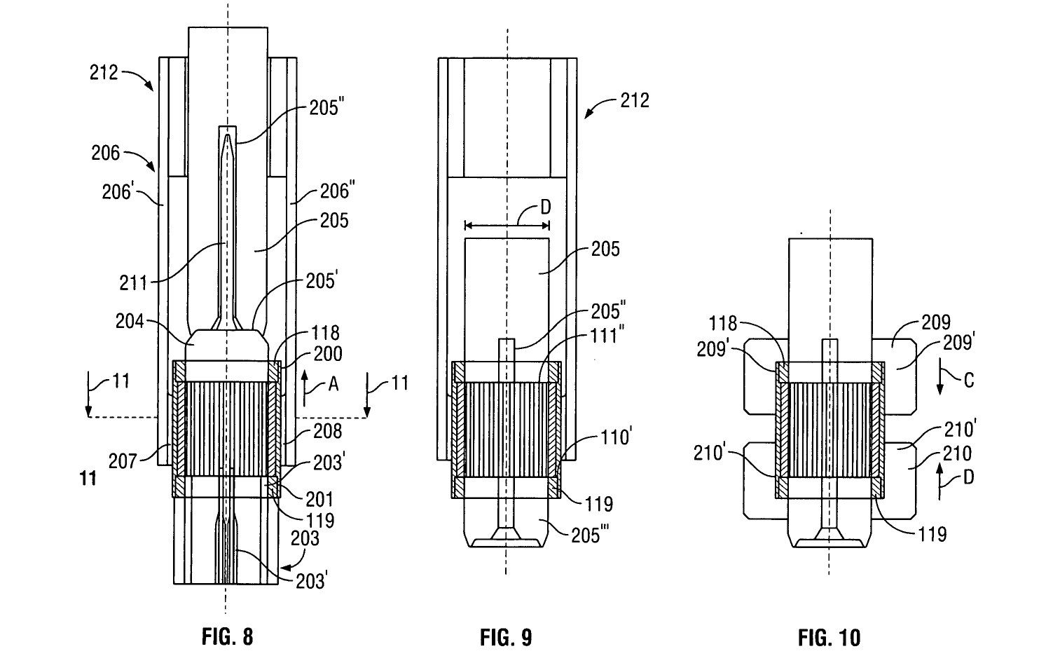

With particular reference to FIGS. 3-5, a coil 112 (FIG. 5) may include segments 116 and 117 placed in spacing 114 of support structure 111. External lines 120 of FIG. 3 schematically show the extension of segments such as segments 118 and 119 of coil 112, which may be placed across opposite axial ends 110′ of core 110. Any one of the external lines of FIG. 3 shows the extension of a segment, such as segment 118 or 119, of a particular coil, where a segment such as segment 116 is placed in a spacing 114 (in FIG. 3 numbered 1-22 in front of each spacing 114), and a segment such as segment 117 is placed in another spacing at a certain angular distance. In the example shown in FIG. 3, the angular distance corresponds to an angular distance of passing beyond ten spacings 114. Adjacent neck portions 111″ delimit and contain segments 116 and 117 with respect to other segments 116 and 117. In other words, neck portions 111″ act as walls which impede certain turns present in segments 116 and 117 from being accidentally positioned amongst turns of other segments 116 and 117. Neck portions 111″ also have a force reaction effect on the coil turns to maintain the coil turns in the respective spacing 114 where they are positioned as a result of winding the coils. (As will be described hereinbelow, an annular member 205 (see FIGS. 8-10) may be provided in connection with the manufacture of core 110 to impede the exit of coil turns from spacings 114, which are otherwise completely free and open for the insertion of a high quantity of wire coils 112.)

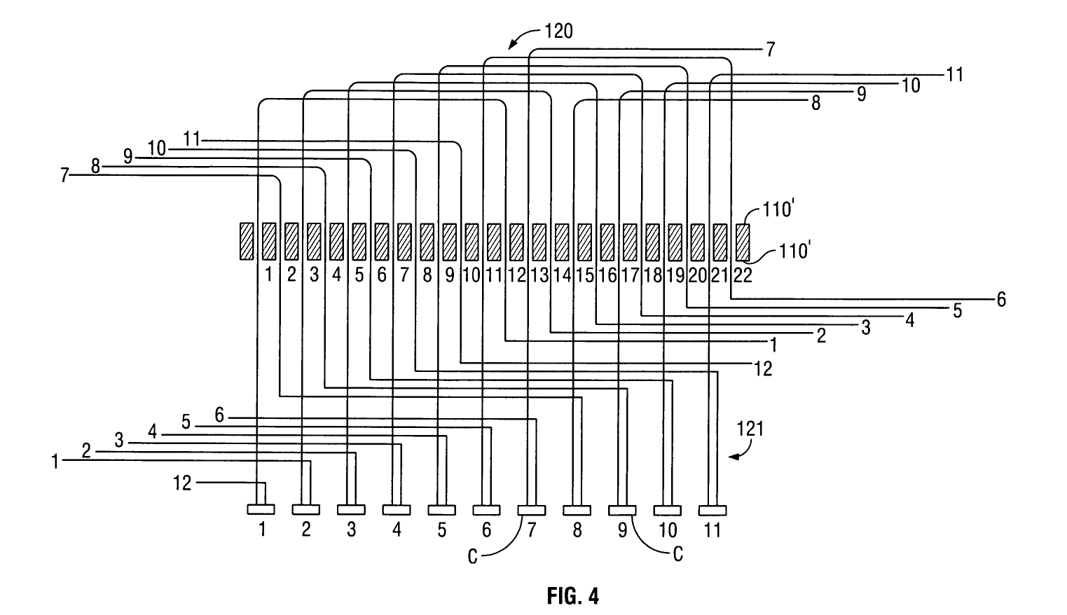

Internal lines 121 of FIG. 3 schematically show leads such as leads 123 or 124 (shown broken in FIG. 5) connected to commutation sectors C (in FIG. 3 numbered 1-11 adjacent each commutation sector). In FIG. 3, some of the leads 123 and 124 are shown departing from the commutation sectors and interrupted at the numbering of the spacing which contains the coil segment to which they belong. Other leads 123 and 124 depart from the commutation sectors and are connected to segments 118 and 119 of adjacent coils (although these other leads are shown interrupted at a black dot in FIG. 3). FIG. 4 shows a schematic view of a complete coursing of leads 123 and 124. In FIG. 4, horizontal lines are interrupted at the left and the right sides of the FIG. Such lines are meant to be connected to each other. In other words, a line numbered with a certain reference at the right of the FIG. is in actuality connected to a line having the same reference at the left of the FIG.

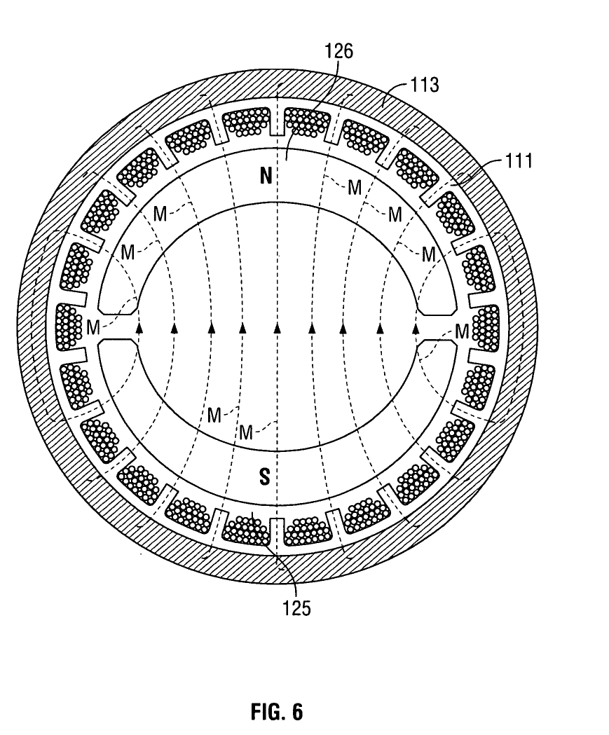

The electrical scheme represented in FIGS. 3-5 is typically that of a DC motor in which core 110 is the stator core with the field switched by mechanical commutation. For example, the commutation sectors shown in FIG. 3 may be assembled as a commutator which is contacted by current conducting brushes rotating with an internal rotor 126 (FIG. 6) placed within core 110. For the described electrical scheme, internal rotor 126 may have two-pole permanent magnetization, as shown in FIG. 6 by the example of North N and South S magnetic sectors placed on internal rotor 126.

Segments 116 and 117 provide conducting paths for electric current to create symmetric lines of magnetic fluxes M for circulation, as shown in FIG. 6. Magnetic fluxes M exit or enter neck portions 111″, pass through internal rotor 126, and close themselves by passing through barrel member 113 (in FIG. 6, some of the magnetic fluxes in barrel member 113 have been shown interrupted for reasons of clarity). The magnetic fluxes pass through annular air gap 125 existing between neck portions 111″ and internal core 126 to produce thrust forces on internal core 126 for causing motion of the internal core. Internal core 126 may be provided with current circulating means to provide magnetization, as would be required in applications with AC supply to core 110 and internal core 126.

Winding of coils such as coil 112 of FIG. 5, and the placement of segments 116, 117, 118, and 119 within respective spacings 114 of core 110, may be achieved by first rotating a wire dispensing flyer around a template to form the coils, and then transferring the coils from the template to selected spacing existing between insertion blades of an insertion tool, as is the technique used for winding coils of induction motor. Once the coils have been placed on the insertion tool, a ram may be passed through the hollow area existing between the insertion blades so that the coils become inserted in respective spacings 114 of core 110 where they need to be allocated. More particularly, core 110 may be aligned over the insertion tool so that the spacing between the insertion blades where segments 116 and 117 are positioned are aligned with spacings 114 for which allocation needs to occur. This technology of winding and inserting the coils in a stator of an induction motor is described, for example, in Becherucci et al. U.S. Pat. No. 6,557,238, which is hereby incorporated by reference herein in its entirety. The wire leads such as wire leads 123 and 124 exiting the coils may be treated as described, for example, in Stratico et al. U.S. patent application Ser. No. 10/817,715, which is hereby incorporated by reference herein in its entirety, in order to course the leads as has been described in the foregoing. A variety of different electrical schemes for core 110 may be accomplished by using the previously mentioned winding, inserting and lead coursing techniques together with core 110 of the present invention. For example, core 110 may be wound according to an electrical scheme so that it can be electronically commutated, as is required in stators of brushless motors, or it can be wound so that it becomes the stator of a variable reluctance motor.

As stated hereinabove, neck portions 111″ act as containing walls for the turns forming segments 116 and 117 of the coils, thereby maintaining the segments in specific allocated spacing 114 as a result of the insertion operation. Consequently, the magnetic energy produced by core 110 is maximized due to the predetermined positioning of the coil turns in spacing 114. Furthermore, portion 111′ may act as an electrical insulation barrier between the coil turns and barrel member 113.

The coil turns may be secured in spacing 114 using, for example, wedge solutions such as those described in Becherucci et al. U.S. patent publication No. US 2004/0046476, published Mar. 11, 2004, which is hereby incorporated by reference herein in its entirety. Alternatively, the coil turns may be secured by filling the gaps existing between coils turns with a plastic compound which bonds the coil turns together. More particularly, the plastic compound may be pressure injected into spacing 114 when segments 116 or 117 are present. A calibration mold member may be fitted within the hollow of core 110 which mates with neck portions 111″. The calibration mold maintains the plastic compound within spacing 114 during the pressure injection operation, and outside a predetermined diameter of core 110 in order to assure the necessary air gap 125 between core 110 and internal core 126.

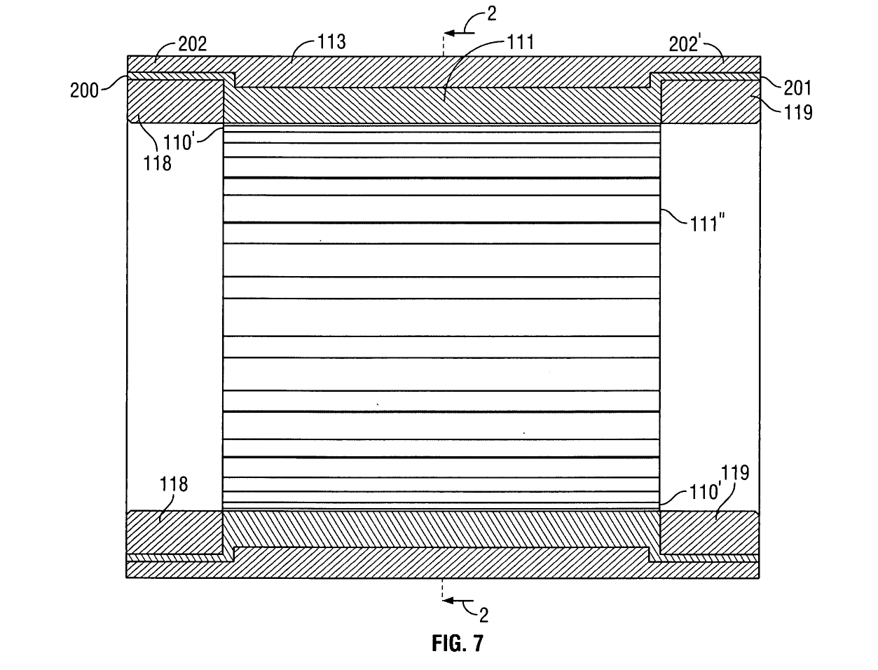

FIG. 7 shows a sectional view of yet another illustrative core in accordance with the present invention. (It should be noted that numbering in connection with the embodiment of FIG. 7 will be the same as the numbering for core 110 of FIG. 2 for like portions of the cores.) In particular, FIG. 7 shows that barrel member 113 and support structure 111 of core 110 may be modified along their extension. More particularly, support structure 111 may have annular portions 200 and 201, which enclose segments 118 and 119 of the coils. Furthermore, barrel member 113 may have annular portions 202 and 202′ encircling annular portions 200 and 201.

FIGS. 8-10 show illustrative manufacturing stages for producing the core of FIG. 7 in accordance with the present invention. It should be noted that certain portions of FIGS. 8-10 are shown transparent and/or without hatching for clarity.

FIG. 8 shows a manufacturing stage in which core 110 is positioned over an insertion tool 203, which is configured as a circular array of insertion blades 203′. Furthermore, ram 204 has passed through insertion tool 203 and is located within core 110. (For reasons of clarity, ram 204 is shown as transparent.) As a result of this manufacturing stage, segments 116 and 117 of coils 112 are located within spacing 114 as shown in FIG. 2, and segments 118 and 119 of the coils are placed across axial ends 110′ of core 110. Also shown in FIG. 8 is member 205 which is axially aligned with ram 204 and in contact with ram 204 along lower end 205′ of member 205. Member 205 may be maintained in alignment with ram 204 by inserting guide rod 211 of ram 204 in central seat 205″ of member 205. The insertion of guide rod 211 in central seat 205″ may occur when ram 204 moves in direction A to reach the position which it has in FIG. 8, while member 205 is already aligned as shown in FIG. 9.

FIG. 9 shows a successive stage in which ram 204 has been withdrawn from the core and has been replaced by member 205 (shown transparent in FIG. 9). Member 205 reaches the position which it has in FIG. 9 by being lowered in a direction opposite to direction A with a pushing means (not shown). This may occur, for example, when ram 204 is being withdrawn from the core with a movement in a direction opposite to direction A. The corresponding motion of member 205 in a direction opposite to direction A may be such that contact at surface 205″ with ram 204 is always maintained until portion 205′″ of member 205 has passed beyond segments 119 placed across lower axial end 110′ of core 110. Member 205 may be configured like a cylinder having an outer diameter D, which allows it to mate with neck portions 111″. In such an example, member 205 acts as a barrier which impedes the exit of coil turns from spacing 114 when ram 204 is being withdrawn from the core. Furthermore, member 205 pushes segments 118 and 119 of the coils firmly against portions 200 and 201 when member 205 is being lowered though the core, thereby causing member 205 to act as former of segments 118 and 119 of the coils.

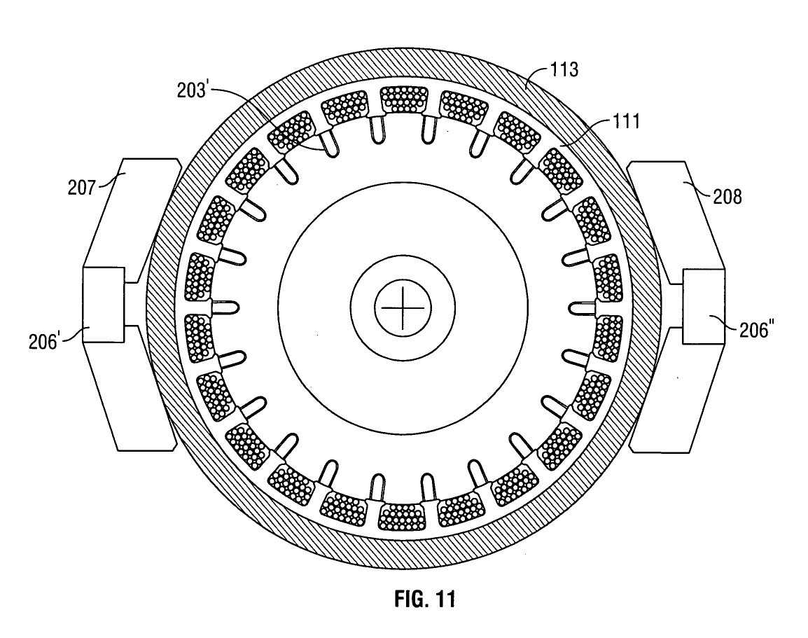

Also shown in FIGS. 8, 9, and 11 is gripper unit 206 having gripping portions 207 and 208, extending from arms 206′ and 206″, in order to grasp barrel member 113. A firm grasp on barrel member 113 keeps core 110 referenced with respect to the other parts shown in FIGS. 8 and 9 (e.g., ram member 204, member 205).

FIG. 9 shows that member 205 has passed through the upper portion 212 of gripper unit 206 and that gripper unit 206 is being moved to transfer core 110 and member 205 to a different location, such as the station illustrated in FIG. 10.

FIG. 10 illustrates a manufacturing stage in which pressing cups 209 and 210 press against segments 118 and 119, respectively. More particularly, pressing cup 209 presses against segment 118 by pressing in direction C, while pressing cup 210 presses against segment 119 by pressing in direction D. The combination of these pressing operations sizes segments 118 and 119 in directions C and D, which are substantially perpendicular to the planes of axial ends 110′ of core 110. Portions 209′ and 210′ of pressing cups 209 and 210, respectively, act as force reacting walls against the tendency of segments 118 and 119 to expand outwardly when the pressing cups press against segments 118 and 119. Similarly, the outer surface of member 205 acts as a force reacting wall against the tendency of segments 118 and 119 to expand inwardly.

In some embodiments, a molten plastic compound may be pressure injected into spacing 114 to secure the coil turns, as described hereinabove. The molten plastic compound may be fed from a pressure injection unit (not shown) to spacing 114 through channels of pressing cups 209 and 210, and through channels of member 205. Member 205 (shown transparent in FIG. 10) may function as a calibration mold member, as described hereinabove.

It will be understood that the foregoing is only illustrative of the principles of the present invention, and that still other modifications can be made by those skilled in the art without departing from the scope and spirit of the invention.

1. A dynamo-electric machine component, comprising:
an annular body portion that is at least partially constructed from an insulating material;
a plurality of members extending radially inward from the body portion forming a plurality of slots therebetween; and
wire coils that are received within the plurality of slots such that each wire coil extends from one slot of the plurality of slots to another slot of the plurality of slots.

2. The component of claim 1, wherein each coil extends from one slot of the plurality of slots to a non-adjacent slot of the plurality of slots.

3. The component of claim 1, wherein each slot of the plurality of slots comprises an opening that extends axially along the body portion and that allows for unimpeded access to the slot for insertion of the wire coils.

4. The component of claim 1, further comprising:
an annular insert that is constructed at least partially from a ferromagnetic material, wherein the insert is embedded within the annular body portion.

5. The component of claim 1, further comprising:
a plurality of inserts constructed at least partially from a ferromagnetic material, wherein the plurality of inserts are embedded within the plurality of members.

6. The component of claim 1, further comprising:
an annular barrel member constructed at least partially from a ferromagnetic material, wherein the barrel member encircles the periphery of the body portion.

7. The component of claim 6, wherein the barrel member extends axially beyond the plurality of slots with respect to a central axis of the body portion.

8. The component of claim 1, wherein first portions of each wire coil are received within the slots, and second portions of each wire coil extend radially outward across opposing axial end portions of the body portion.

9. The component of claim 1, further comprising:
a commutator that is received within the body portion, wherein a gap of air exists between the periphery of the commutator and the wire coils received within the slots.

10. The component of claim 1, wherein the wire coils are secured within the plurality of slots with a bonding compound.

11. The component of claim 1, wherein the body portion extends axially beyond the plurality of slots with respect to a central axis of the body portion.

12. Apparatus for assembling wire coils on a dynamo-electric machine component, the component having an annular body portion and a plurality of members extending radially inward from the body portion forming a plurality of slots therebetween, the apparatus comprising:
a ram member configured to be received within the body portion of the component to position a first portion of the wire coils within the plurality of slots and a second portion of the wire coils across opposing axial end portions of the body portion; and
an annular member configured to be received within the body portion when the ram member is withdrawn from the body portion such that the first portion of the wire coils maintains its positioning with respect to the slots.

13. The apparatus of claim 12, wherein the annular member is further configured to press the second portion of the wire coils against the body portion.

14. The apparatus of claim 12, further comprising:
first and second cup members, wherein the first and second cup members are configured to be received circumferentially around the annular member, and wherein the first and second cup members are configured to apply respective forces to the second portion of the wire coils, thereby further pressing the second portion of the wire coils against the body portion.

15. The apparatus of claim 14, wherein the first and second cup members are configured to dispense a bonding compound such that the second portion of the wire coils is affixed in its position.

16. The apparatus of claim 12, wherein the annular member is configured to dispense a bonding compound such that the first and second portions of the wire coils are affixed in their respective positions.

17. The apparatus of claim 12, wherein a diameter of the annular member is such that the annular member engages free end portions of the members extending from the body portion of the component.

18. The apparatus of claim 12, further comprising:
a gripper unit comprising first and second gripping portions configured to engage the periphery of the body portion of the component such that the position of the body portion is maintained when one or both of the ram member and annular member interact with the wire coils.

19. A method for assembling wire coils on a dynamo-electric machine component, the component having an annular body portion and a plurality of members extending radially inward from the body portion forming a plurality of slots therebetween, the method comprising:
providing apparatus for assembling the wire coils on the component comprising a ram member and an annular member;
advancing the ram member within the body portion of the component such that a first portion of the wire coils are positioned within the plurality of slots and a second portion of the wire coils are positioned across opposing axial end portions of the body portion;
advancing the annular member within the body portion of the component when the ram member is withdrawn from the body portion such that the first portion of the wire coils maintains its positioning with respect to the slots.

20. The method of claim 19, wherein advancing the annular member within the body portion of the component further comprises pressing the second portion of the wire coils against the body portion with the annular member.

21. The method of claim 19, wherein the annular member is advanced within the body portion of the component while the ram member is withdrawn from within the body portion of the component.

22. The method of claim 19, wherein the apparatus further comprises first and second cup members, the method further comprising:
positioning the first and second cup members circumferentially around the annular member; and
advancing the first and second cup members axially with respect to a central axis of the annular member such that the first and second cup members apply respective forces to the second portion of the wire coils, thereby further pressing the second portion of the wire coils against the body portion.

23. The method of claim 22, further comprising:
dispensing a bonding compound with the first and second cup members such that the second portion of the wire coils is affixed in its position.

24. The method of claim 19, further comprising:
dispensing a bonding compound with the annular member such that the first and second portions of the wire coils are affixed in their respective positions.

25. The method of claim 19, wherein the apparatus further comprises a gripper unit comprising first and second gripping portions, the method further comprising:
engaging the periphery of the body portion of the component with the first and second gripping portions such that the position of the body portion is maintained while the ram member and annular member are advanced within the body portion.

26. The method of claim 25, further comprising:
moving the component and annular member to a location of the first and second cup members with the gripper unit.
